(19) United States
(12) Patent Application Publication
(10) Pub. No.: US 2004/0063063 A1
(43) Pub. Date: Apr. 1, 2004

(54) Dental cartridge

(76) Inventors: Joshua James Cheetham, East Malvern (AU); Paul James Farrar, West Melbourne (AU)

Correspondence Address: William H Holt, LAW OFFICES OF WILLIAM H HOLT, Unit 2 First Floor, 1423 Powhatan Street, Alexandria, VA, 22314, US

(21) Appl. No.: 10/416,037

(22) PCT Filed: Nov. 9, 2001
(86) PCT No.: PCT/AU01/01458

(30) Foreign Application Priority Data
Nov. 9, 2000 (AU) PR 1310

(51) Int. Cl. A61C 5/04

(52) U.S. Cl. 433/90

(57) ABSTRACT

A dental cartridge (10) comprising a container portion (14) and a nozzle (12). The container portion (14) includes an aperture (34) having a first end (38) adjacent the interior of the container portion (14) and a second end (36) adjacent the exterior of the container portion (14). The nozzle (12) is received within the second end (36) of the aperture (34) and the first end (38) of the aperture (34) is arranged to prevent the nozzle (12) passing therethrough. The nozzle (12) is then fixed within the aperture (34).

### BRIEF DESCRIPTION OF THE INVENTION

The present invention relates to a dental cartridge.

### FIELD OF THE INVENTION

It is known to require, in dentistry, a means of applying a substance of relatively low viscosity to a precise location in a patient's tooth. Such application has generally been achieved by the use of a dental cartridge including a container within which the substance may be stored, a nozzle through which the substance is delivered and a plunger mechanism for forcing the substance from the container through the nozzle to the desired location.

A known type of dental cartridge includes a metal nozzle attached to a container composed of plastics material. Such a cartridge is disclosed in U.S. Pat. Nos. 5,052,927 and 5,336,088. The nozzle of this type of cartridge includes a flanged area at one end of the nozzle. The cartridge is manufactured by the insertion of the flanged end of the nozzle into an aperture within the container. The container is constructed from a resilient material, and the aperture thus closes around the nozzle, allowing a seal to form between the flanged area of the nozzle and the wall of the container. This type of dental cartridge has several disadvantages. The forces applied to the nozzle as it is inserted into the container are significant, and require a nozzle to be of sufficient size and strength to prevent damaging or breaking of the nozzle during this process. The formation of the seal between the nozzle and the container is not always of sufficient strength to withstand a pushing force applied to the substance during use of the cartridge. The container must be resilient in order for the nozzle to be inserted, and thus cannot be formed from a rigid material. In use, a bending force applied to the nozzle can cause the nozzle to be pulled out of the container and thus failure of the cartridge.

The present invention attempts to overcome at least in part some of the aforementioned disadvantages of previous dental cartridges.

### SUMMARY OF THE INVENTION

In accordance with one aspect of the present invention there is provided a dental cartridge characterised by comprising a container portion including an aperture, the aperture having a first end adjacent an interior surface of the container portion and a second end adjacent an exterior surface of the container portion and a nozzle having., an substantially cylindrical end arranged to be inserted within the aperture in the container portion, wherein the second end of the aperture includes a widened portion arranged to receive an adhesive means around the nozzle to secure the nozzle to the container portion and the first end of the aperture is arranged to prevent passage of the nozzle therethrough.

### DESCRIPTION OF THE DRAWINGS

The present invention will now be described, by way of example, with reference to the accompanying drawings, in which:

FIG. 1 is a cut away perspective view of a dental cartridge in accordance with the present invention;

FIG. 2 is a cross sectional view of the dental cartridge of FIG. 1; and

FIG. 3 is a cross sectional view of a portion of the dental cartridge of FIG. 1 prior to, assembly.

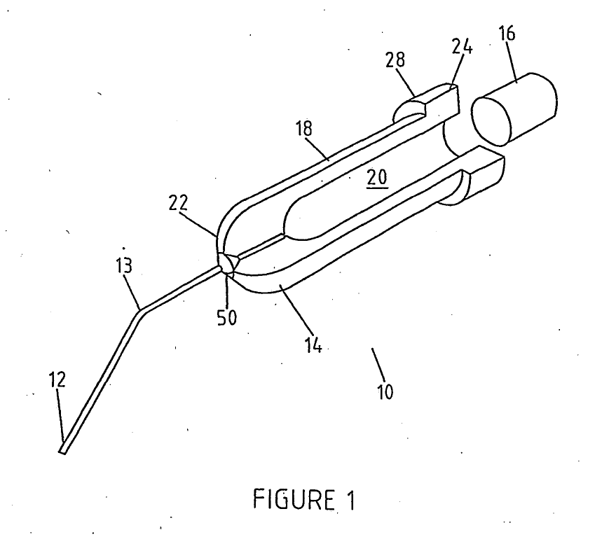

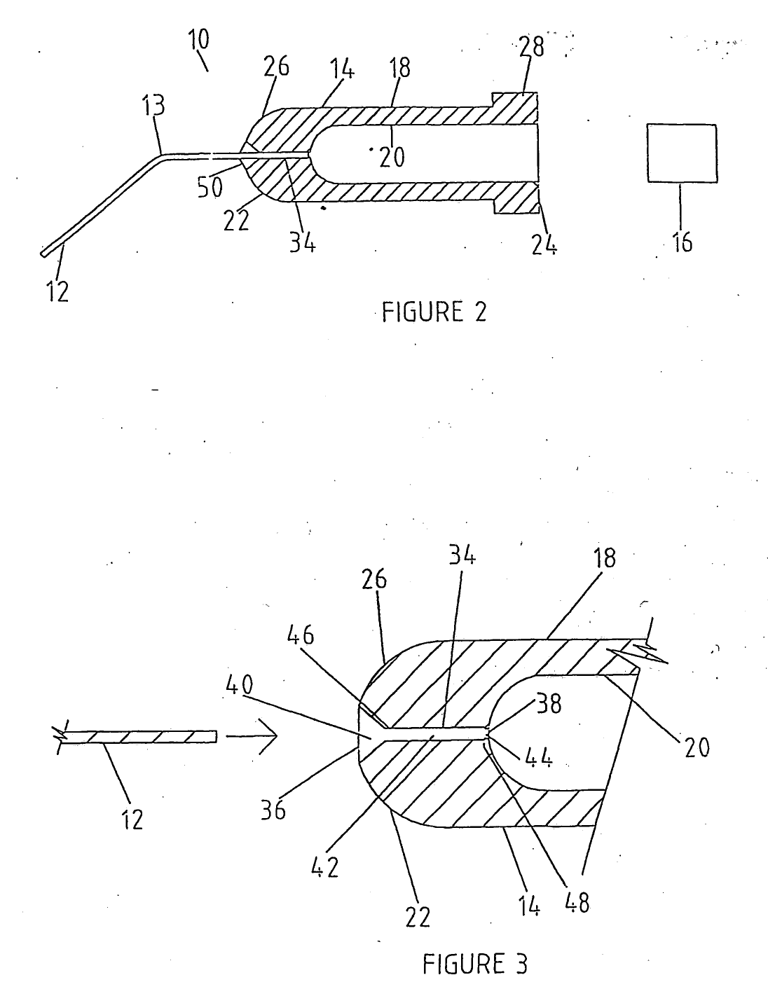

### DESCRIPTION OF THE INVENTION

Referring to the Figures, there is shown a dental cartridge 10 having a nozzle 12, a container portion 14 and a plunger 16. The nozzle 12 is tubular, with a substantially circular cross sectional shape. The nozzle 12 may include a bend 13 along the length of the nozzle 12. The container portion 14 has an exterior surface 18 which is substantially cylindrical in shape. The container portion 14 is enclosed at a first end 22 thereof by a part-spherical end portion 26. Further, the container portion 14 is open at a second end 24 thereof. A dental substance can thus be stored within the container portion 14 in a region extending from the first end 22 towards the second end 24.

The container portion 14 has an interior surface 20 which generally follows the shape of the exterior surface 18, having a substantially cylindrical portion and a part spherical portion.

A flange portion 28 is arranged about the exterior surface 18 at the second end 24 of the container portion 14, and allows the dental capsule 10, in use, to be held within an applicator (not shown).

As shown in FIG. 3, the container portion 14 includes an aperture 34 extending through the part-spherical end portion 26. The aperture 34 has a first end 38 adjacent the interior surface 18 and a second end 36 adjacent the exterior surface 20. The aperture 34 has a first portion 44 extending from the first end 38 of the aperture to a first location 48 along the aperture 34, a second portion 42 extending from the first location 48 to a second location 46 adjacent the second end 36, and a third portion 40 extending between the second location 46 and the second end 36.

The second portion 42 is substantially cylindrical in cross-sectional shape, and is arranged to have dimension similar to that of the nozzle 12. The third portion 40 is substantially frusto-conical in shape, and tapers outwardly from the cross sectional dimension of the second portion 42 at the second location 46 to a larger cross sectional dimension at the second end 36. The first portion 44 is substantially cylindrical in shape, with a cross sectional dimension smaller than that of the nozzle 12.

The plunger 16 is substantially cylindrical in shape, with an external diameter similar to the diameter of the internal surface 20 of the container portion 14.

The dental cartridge 10 is constructed by the insertion of an end of the nozzle 12 into the second end 36 of the aperture 34. The nozzle 12 is introduced into the third portion 40 and the second portion 42 of the aperture 34, but is restrained from further insertion by the smaller diameter of the first portion 44. An adhesive substance 50 is then applied around the nozzle 12 at the first end 36 of the aperture 34 and allowed to cure. The nozzle 12 is thus firmly connected to the container portion 14.

In use, a dental substance is held within the container portion 14. The plunger 16 is then introduced into the second end 24 of the container portion 14, and a pressing force is applied. The pressing force causes the dental substance to be urged into the first end 38 of the aperture 34 and to the desired location in a patient's tooth via the nozzle 12. Modifications and variations as would be apparent to a skilled addressee are deemed to be within the scope of the present invention.

1. A dental cartridge characterised by comprising a container portion including an aperture, the aperture having a first end adjacent an interior surface of the container portion and a second end adjacent an exterior surface of the container portion and a nozzle having an substantially cylindrical end arranged to be inserted within the aperture in the container portion, wherein the second end of the aperture includes a widened portion arranged to receive an adhesive means around the nozzle to secure the nozzle to the container portion and the first end of the aperture is arranged to prevent passage of the nozzle therethrough.

2. A dental cartridge as claimed in claim 1, characterised in that the aperture has a first portion adjacent the first end of the aperture and a second portion adjacent the first portion, the second portion having a cross sectional size dimensioned such that the nozzle may be received within the second portion and the first portion having a cross sectional size smaller than that of the first portion such that the nozzle cannot pass through the first portion.

3. A dental cartridge as claimed in claim 2, characterised in that the widened portion of the aperture comprises a third portion between the second portion and the second end of the aperture, the cross-section of the third portion being substantially frusto-conical in shape.

4. A dental cartridge as claimed in any one of the preceding claims, characterised in that the container is formed from a compound of a rigid material.

5. A dental cartridge as claimed in any one of the preceding claims, characterised in that the container portion includes a flanged portion adjacent an end of the container portion for engagement within an applicator.
